(19) United States
(12) Patent Application Publication
(10) Pub. No.: US 2018/0321198 A1
(43) Pub. Date: Nov. 8, 2018

(54) PRESSURE NOISE FILTER FOR CHROMATOGRAPHIC SYSTEMS

(71) Applicant: Waters Technologies Corporation, Milford, MA (US)

(72) Inventors: Abhijit Tarafder, Franklin, MA (US); Michael O. Fogwill, South Grafton, MA (US); Joshua A. Shreve, Franklin, MA (US); Joseph D. Michienzi, Plainville, MA (US); Steven J. Ciavarini, Natick, MA (US)

(21) Appl. No.: 15/967,752

(22) Filed: May 1, 2018

Related U.S. Application Data
(60) Provisional application No. 62/492,389, filed on May 1, 2017.

(51) Int. Cl. G01N 30/28; B01D 15/10

(52) U.S. Cl. CPC G01N 30/28; B01D 15/10

(57) ABSTRACT

The present disclosure relates generally to a system and a method for improving performance of a chromatography system using a highly-compressible fluid based mobile phase (e.g., CO₂). In particular, the present disclosure relates to a system that uses a conduit, such as a convergent-divergent nozzle, for reducing pressure noise in a chromatography system using a highly-compressible fluid based mobile phase. The chromatography system can include a conduit, such as a convergent-divergent nozzle, disposed downstream of the column to reduce or prevent the propagation of pressure or density pulses from a back pressure regulator.

### RELATED APPLICATIONS

This application claims priority to U.S. Provisional Application No. 62/492,389, filed on May 1, 2017, entitled “Pressure Noise Filter for Chromatographic System,” and which is incorporated herein by reference in its entirety.

### TECHNICAL FIELD

The present disclosure relates generally to a system and a method for improving performance of a chromatography system using a highly-compressible fluid based mobile phase. In particular, the present disclosure relates to a system that uses a device, e.g., a convergent-divergent nozzle, for reducing pressure noise in a chromatographic system using a highly-compressible fluid based (e.g., CO₂ or Freon) mobile phase.

### BACKGROUND OF THE INVENTION

Chromatography systems identify and quantitate separated components using a variety of detectors, including UV/VIS, photo diode array, fluorescence and mass spectrometry. The performance of these detectors can be limited by a number of factors or conditions that occur within the chromatography system. One of these factors, especially in a chromatography system using a highly-compressible fluid based mobile phase (e.g., CO₂-based chromatography), is the presence of pressure or density waves propagating throughout the system. These pressure or density waves can increase the baseline noise of the detector and reduce the detector's signal-to-noise ratio (S/N).

The signal-to-noise ratio is one of the primary measures for determining the performance of a chromatography system. The noise is measured between two points on the baseline where no sample elutes. The signal is measured from the middle of the baseline to the top of a standard sample peak. S/N is merely the signal divided by the noise. To improve the performance of a chromatography system, e.g., improve the limit of detection or limit of quantification, the S/N can be increased. One way to accomplish this is by decreasing the noise.

### SUMMARY OF THE INVENTION

The present disclosure relates to a system that uses a device for reducing pressure noise in a chromatography system using a highly-compressible fluid based mobile phase. In particular, the present disclosure relates to a system that uses a device, e.g., a convergent-divergent nozzle (CDN), for reducing pressure noise in a chromatographic system using a highly-compressible fluid based mobile phase, such as for example a mobile phase including carbon dioxide. The device can be any device that is configured to match or substantially match the mobile phase velocity of a mobile-phase fluid passed through the device to the speed of sound through the same mobile phase fluid.

In one aspect, the present disclosure relates to a composition for reducing pressure noise in a chromatography system including a conduit having a front opening with a first cross-sectional area, a back opening with a second-cross sectional area, and a throat section with a third cross-sectional area located between the first and second openings, wherein the third cross-sectional area is less than about 90% of both individual values of the first and second cross-sectional areas; and a heat exchanger in thermal communication with the conduit.

Embodiments of this aspect can include one or more of the following features. In some embodiments, the conduit includes a plurality of overlaying panels and the composition further includes one or more shutters attached to the external surface of the plurality of overlaying panels. The overlying panels are capable of adjusting the size of the front opening, back opening, throat section, or combinations thereof, and a feedback loop to adjust the size of one or more shutters. As used herein, the term capable of can include configured to or adapted to. In certain embodiments, the conduit can have a relatively constant pitch between the front opening and the throat section and between the back opening and the throat section. In some embodiments, the cross-sectional area of the front opening, back opening, and the throat section can be substantially circular.

In another aspect, the present disclosure relates to a chromatography system including a pump for pumping a flow stream comprising a highly-compressible fluid based mobile phase, a column disposed downstream of the pump, a detector disposed downstream of the column, a convergent-divergent nozzle, or similar device, disposed downstream of the column, and a back pressure regulator downstream of the nozzle.

Embodiments of this aspect can include one or more of the following features. In some embodiments, the back pressure regulator of the chromatography system can have a movable valve shaft. The chromatography system can also include a pressure transducer probe connected to the nozzle capable of measuring the pressure of the highly-compressible fluid based mobile phase in the throat section, and a heat exchanger connected to or in close proximity of the nozzle capable of heating the highly-compressible fluid based mobile phase flowing through the nozzle. The system can further include a feedback controller connected to the detector and the heat exchanger, wherein the controller is capable of determining the pressure noise in the detector and adjusting the heat exchanger to minimize the pressure noise. The nozzle can have two or more channels wherein each channel has a throat having a different cross-sectional area. Each cross-sectional area of the nozzle can be adjusted.

In another aspect, the present disclosure relates to a method of improving the performance of a chromatography system including the steps of filtering pressure noise in a highly-compressible fluid based mobile phase flowing through the system. The method can include utilizing a device, such as a convergent-divergent nozzle, positioned between a detector and a back pressure regulator in the system. The improved performance can include decreasing baseline noise in a detector in the chromatography system. Filtering can include reducing the propagation of pressure or density pulses from a back pressure regulator in a chromatography system. Further, filtering can include obtaining choked flow in the mobile phase (e.g., a mobile phase including CO₂ or other highly-compressible fluid) flowing through the system.

In another aspect, the present disclosure relates to a method of improving the performance of a chromatography system including the step of flowing or passing the mobile phase through a device or conduit, e.g., a convergent-divergent nozzle, wherein the device or conduit is configured to match or substantially match the mobile phase velocity of the mobile-phase passing through the device or conduit to the speed of sound through the same mobile phase fluid.

The systems, methods and apparatus of the present disclosure provide several advantages over the prior art. The present disclosure can reduce or prevent pressure fluctuation originating at the downstream in a chromatography system that uses CO₂ or other density changing/highly-compressible fluid mobile phase from propagating upstream. The systems, methods and apparatus of the present disclosure can accomplish the reduction or prevention by obtaining a choked flow, or a near choked flow, condition within the throat of a device or conduits, such as a convergent-divergent nozzle. By reducing or preventing pressure fluctuations to propagate to the detector, the systems, methods and apparatus of the present disclosure can minimize baseline noise in chromatograms. Such an improvement can significantly increase the sensitivity of the system's detector.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1 shows an exemplary convergent-divergent nozzle for pressure reducing noise in a chromatography system.

FIG. 2 shows another exemplary convergent-divergent nozzle for pressure reducing noise in a chromatography system. The dimensions of the nozzle are adjustable.

FIG. 3 shows an exemplary schematic diagram of a chromatography system wherein density waves are generated by the movement of the automated back pressure regulator (ABPR) valve shaft. The waves propagate throughout the system and can interfere with and create changes in the chromatography system including the generation of base-line noise in a detector.

FIG. 4 shows another exemplary schematic diagram of a chromatography system wherein density waves generated by the movement of the ABPR valve shaft. The waves do not propagate throughout the system past the convergent divergent nozzle.

FIG. 5 shows an exemplary example of how pressure and velocity change in a converging diverging duct.

FIG. 6 shows an exemplary convergent divergent nozzle having temperature control elements to adjust the temperature of the mobile phase at the nozzle to ensure choke flow. The nozzle also has a pressure transducer to measure the pressure of the mobile phase at the throat of the nozzle.

FIG. 7 shows an exemplary system having a convergent divergent nozzle and a temperature controller to fine-tune the temperature of the mobile phase in the nozzle to ensure choked flow. The controller is connected to the detector and can make adjustments based on the detector signal or baseline noise.

### DETAILED DESCRIPTION

The present disclosure relates generally to a system and a method for improving performance of a chromatography system in which the mobile phase imparts a compression-decompression density or pressure wave. In particular, the present disclosure relates to a system that uses a device, e.g., a convergent divergent nozzle, for reducing pressure noise in a chromatographic system using a CO₂ based or other density changing mobile phase.

Highly-compressible fluid chromatography is a type of chromatography that is configured to operate with a solvent that includes a fluid (e.g., carbon dioxide, Freon, etc.) that is in a gaseous state at ambient/room temperature and pressure. Typically, highly-compressible fluid chromatography involves a fluid that experiences noticeable density changes over small changes in pressure and temperature. Although highly-compressible fluid chromatography can be carried out with several different compounds, in the current document CO₂ will be used as the reference compound as it is currently the most commonly employed. It is noted that highly-compressible fluid chromatography has also been referred to as CO₂-based chromatography, or in some instances as supercritical fluid chromatography (SFC), especially where CO₂ is used as the mobile phase.

The generation of pressure or density waves related to pumping highly-compressible fluids and attempting to hold certain pressures across a chromatographic system using highly-compressible fluid as the mobile phase can interfere with the development of robust and reliable separations. Despite the introduction of chromatography systems using two-stage pumps (e.g., for separating compression and metering) and two layer resistors for back pressure regulation, these interferences still exist.

In one embodiment, the present disclosure relates to a composition (e.g., a structure) for reducing pressure noise in a chromatography system including a conduit having a front opening with a first cross-sectional area, a back opening with a second-cross sectional area, and a throat section with a third cross-sectional area located between the front and back area, wherein the third cross-sectional area is less than about 90% of both individual values of the first and second cross-sectional areas; and a heat exchanger in thermal communication with the conduit.

The chromatography system can include any chromatography system using a mobile phase including a highly-compressible fluid. For example, the system can be a supercritical fluid chromatography (SFC) system. The highly-compressible fluid can include any highly-compressible fluid known to one skilled in the art that are used to perform chromatography including carbon dioxide. In some embodiments, the mobile phase can contain carbon dioxide, water, argon, nitrogen, helium, hydrogen, various CFCs (e.g., Freon), fluorocarbons, SF₆, N₂O or combinations thereof. In certain embodiments, the mobile phase includes additives, modifiers, and/or co-solvents, such as, for example, methanol can be introduced into the mobile phase. Other possible modifiers or co-solvents include, but are not limited to, acetonitrile and isopropanol. The mobile phase can contain about, or greater than about, 10%, 20%, 30%, 40%, 50%, 60%, 70%, 80%, 90%, 95%, 98%, 99% or 100% highly-compressible fluid, e.g., carbon dioxide.

The pressure noise of a chromatography system includes pressure or density waves that are produced in the downstream of the chromatography system by the moving parts of the system and propagate through the upstream of the system passing through the detectors. The pressure noise is part of the baseline noise and therefore, having the pressure noise in the system increases the baseline noise. As the baseline noise increases, the signal-to-noise ratio decreases, therefore, the performance of the chromatography system decreases.

The systems, methods and apparatus of the present disclosure can reduce the pressure noise compared to an equivalent, or substantially similar, system, method and apparatus not having a conduit, e.g., convergent divergent nozzle. The pressure noise can be reduced by about 1%, 2%, 3%, 4%, 5%, 10%, 15%, 20%, 25%, 30%, 35%, 40%, 45% or about 50%. These values can also define a range, such as about 10% to about 30%.

The conduit can be any conduit having a front opening, a back opening and a throat opening in the middle that can reduce the pressure noise in a chromatography system using a highly-compressible fluid based mobile phase.

The function of the device, structure or conduit is to reduce pressure fluctuation, in particular fluctuations originating at the downstream, in a chromatographic system that uses a highly-compressible fluid based mobile phase, from propagating throughout, in particular to its upstream. The system can reduced these fluctuations by obtaining choked flow condition, or near choked flow conditions, through the throat section of the conduit, e.g., convergent divergent nozzle. By reducing pressure fluctuation to propagate beyond a certain point the conduit can minimize the baseline noise, typically witnessed in chromatograms using a highly-compressible fluid based mobile phase, which can improve or significantly improve the UV detection sensitivity.

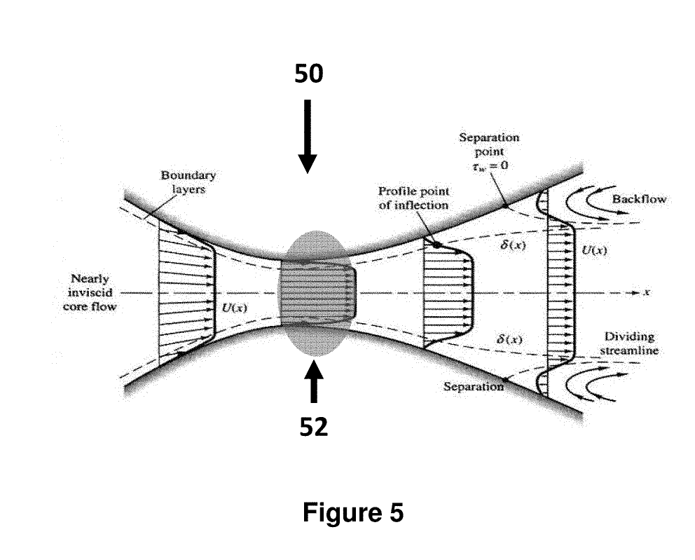

“Choked flow” is an effect of highly-compressible fluid, or a highly-compressible fluid based mobile phase, passing through a narrow region, where the velocity of the fluid becomes “restricted” or “choked.” Choked flow is associated with the Venturi effect. When a fluid, flowing at a given pressure and temperature, passes through a restriction (such as the throat of a CDN) into a lower pressure environment, the fluid velocity increases (see, e.g., FIG. 5). FIG. 5 shows an example of how pressure and velocity change in a convergent divergent nozzle 50. At initial subsonic upstream conditions, the conservation of mass principle requires the fluid velocity 52 to increase as it flows through the smaller cross-sectional area of the restriction. At the same time, the Venturi effect causes the static pressure, and therefore the density, to decrease downstream beyond the restriction. Choked flow is a limiting condition where the mass flow will not increase with a further decrease in the downstream pressure environment while upstream pressure is fixed. The limited parameter is velocity, and thus mass flow can be increased with increased upstream pressure (increased fluid density). For homogeneous fluids, the physical condition at the throat where choking occurs for adiabatic conditions, can be when the fluid velocity is at sonic conditions, i.e., at a Mach number of 1. Therefore, a pressure fluctuation generated at the downstream of the CDN can be reduced or stopped from propagating upstream if the fluid velocity at the throat of the CDN becomes equal, or nearly equal, to the speed of sound (Mach 1) through that medium.

In one aspect, the present disclosure relates to a method of improving the performance of a chromatography system including the step of flowing (or passing) the mobile phase fluid through a device, e.g., a convergent-divergent nozzle, wherein the device is configured to match or substantially match the mobile phase velocity of the mobile-phase passing through the device to the speed of sound through the same mobile phase fluid. In another aspect, the present disclosure relates to a method of improving the performance of a chromatography system including the step of matching the mobile phase velocity of the mobile phase passing through a device to the speed of sound through the same mobile phase fluid. The mobile phase velocity and the speed of sound through the same can be matched within the device wherein the respective values differ by less than about 20%, 15, 10, 9, 8, 7, 6, 5, 4, 3, 2 or about 1%. These values can be used to define a range, such as about 10 to about 1%.

The device can also be configured wherein the mobile phase fluid exhibits a relatively minor pressure drop while flowing (or passing) through the device. In one embodiment, the device is a CND wherein the mobile phase fluid exhibits a relatively minor pressure drop while flowing (or passing) through the device. The mobile phase pressure drop through the device can be less than about 50%, 45, 40, 35, 30, 25, 20, 15, 10, 9, 8, 7, 6, 5, 4, 3, 2 or about 1%. These values can be used to define a range, such as about 20 to about 5%.

The conduit can be made of various materials. In some embodiments, the conduit is made of metals, rigid polymers, or any combination thereof.

The throat section can be located closer to the front opening than the back opening. The throat section can also be located closer to the back opening than the front opening. The length of the conduit can be about 5 mm, 10, 15, 20, 25, 30, 35, 40 or about 50 mm. These values can be used to define a range, such as about 10 mm to about 25 mm. If the throat section is located closer to the front opening, the length of the front opening to the throat section can be about 4 mm, 9, 14, 19, 24, 29, 34, 36 or about 49 mm. These values can be used to define a range, such as about 14 mm to about 36 mm. If the throat section is located closer to the back opening, the length of the back opening to the throat section can be about 4 mm, 9, 14, 19, 24, 29, 34, 36 or about 49 mm. Similarly, these values can be used to define a range, such as about 14 mm to about 36 mm.

Each of the front opening, the back opening and the throat opening has a cross sectional area. The cross sectional area of the front opening, back opening and the throat opening can have different shapes. For example, they can be circular or oval. In some embodiments, the cross sectional area of the front opening, back opening, and the throat section are substantially circular.

The dimensions of the front opening, back opening and the throat section can vary. In some embodiments, the first cross-sectional area of the conduit (front opening) and the second cross-sectional area of the conduit (back opening) are the same, or substantially the same, value. In other embodiments, the first cross-sectional area and the second cross-sectional area are not the same. The first cross-sectional area and the second cross-sectional area of the conduit can be about 0.01 mm², 0.05 mm², 0.1 mm², 0.5 mm², 1 mm², 5 mm², 10 mm², 15 mm², 20 mm², 25 mm², 30 mm², 35 mm², 40 mm², 50 mm², 60 mm², 70 mm², 80 mm², 90 mm² or about 100 mm². These values can be used to define a range, such as about 20 mm² to about 100 mm².

The throat section of the conduit has the third-cross sectional area. The third cross-sectional area can be less than about 90% of both the individual values of the first and second cross-sectional area. The third cross-sectional area can be about 0.01%, 0.05%, 0.1%, 0.5%, 1%, 5%, 10%, 20%, 30%, 40%, 50%, 60%, 70%, 80%, or about 90% of both the individual values of the first and second cross-sectional area. These values can be used to define a range, such as about 50% to about 90%.

The ratios of the first, second and the third cross sectional area can vary. The ratio of the first cross sectional area to the second cross sectional area can be about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, 3, 3.2, 3.4, 3.6, 3.8, 4, 4.2, 4.4, 4.6, 4.8, 5, 5.2, 5.4, 5.6, 5.8, 6, 6.2, 6.4, 6.6, 6.8, 7, 7.2, 7.4, 7.6, 7.8, or about 8. These values can be used to define a range, such as about 0.8 to about 1.2. The ratio of the third cross sectional area to the first cross sectional area can be about 0.01, 0.02, 0.03, 0.04, 0.05, 0.06, 0.07, 0.08, 0.09, 0.1, 0.2, 0.3, 0.4, 0.5, 0.6, 0.7, 0.8, or about 0.9. These values can be used to define a range, such as about 0.02 to about 0.5. The ratio of the third cross sectional area to the second cross sectional area can be about 0.01, 0.02, 0.03, 0.04, 0.05, 0.06, 0.07, 0.08, 0.09, 0.1, 0.2, 0.3, 0.4, 0.5, 0.6, 0.7, 0.8, or about 0.9. Similarly, these values can be used to define a range, such as about 0.03 to about 0.3.

The conduit can have a relatively constant pitch between the front opening and the throat section, and between the back opening and the throat section. The pitch of the conduit is the slope of the surface connecting the front opening to the throat section or the back opening to the throat section.

The front pitch and the back pitch can have the same, substantially the same, or different values. The front pitch can be 60°, 50°, 45°, 40°, 35°, 30°, 25°, 20°, 15°, or about 10°. These values can be used to define a range, such as about 50° to about 10°. The back pitch can be 60°, 50°, 45°, 40°, 35°, 30°, 25°, 20°, 15°, or about 10°. These values can be used to define a range, such as about 50° to about 10°. The ratio of the front pitch to the back pitch can be 1:1, 1:0.99, 1:0.98, 1:0.96, 1:0.94, 1:0.92, 1:0.9, 1:0.88, 1:0.86, 1:0.84, 1:0.82, or about 1:0.8. In one embodiment, the conduit can have a cylinder shape. In another embodiment, the conduit does not have a cylinder shape.

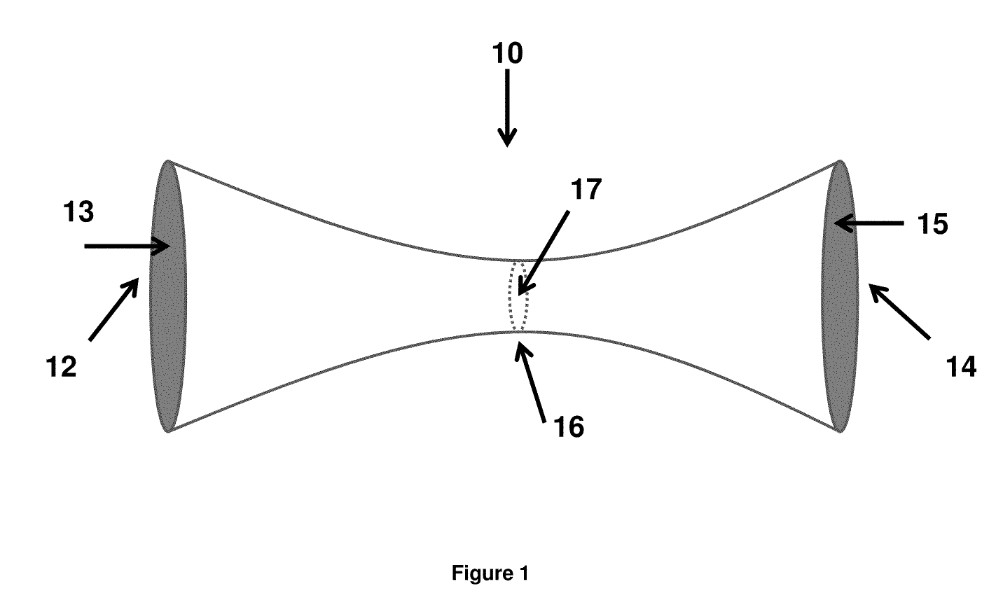

FIG. 1 shows a conduit 10 having a circular front opening 12 with a first cross-sectional area 13, a circular back opening 14 with a second cross-sectional area 15, and a circular throat section 16 with a third cross sectional area 17. The throat section is located between the front and back openings. The front and back opening have substantially similar cross-sectional area. The cross-sectional area of the throat is about 10% of the front cross-sectional area. The cross-sectional area of the throat is about 10% of the back cross-sectional area. Both the front and the back pitches are substantially constant.

The conduit can be made of any materials that can reduce the pressure noise in a chromatography system using a highly-compressible fluid based mobile phase. For example, the conduit can be made of various plastic or metals or any combination of metal and plastic or alloy and plastic. In one embodiment, the inside surface of the device can be sufficiently smooth as to reduce or limit the creation of any eddies inside the flow that would negate the noise reducing ability of the device or conduit.

The composition can also include a heat exchanger in thermal communication with the conduit. The heat exchanger can be any heat exchanger capable of adjusting the temperature of the mobile phase flowing through the conduit. For example, the heat exchanger can be a tubular, plate-type or extended surface heat-exchanger. It can be either single-pass or multi-pass at the heating/cooling fluid side. In another embodiment Peltier elements can be used to heat/cool the conduit. For experiments where the composition and/or density of the mobile-phase is varied as a function of time, the heat-exchange mechanism should be fast enough to reciprocate to these changes. The temperature of the system, or of any one component in the system, e.g., mobile phase, can be −50° C., −45, −40, −35, −30, −25, −20, −15, −10, −5, 0, 5, 10, 15, 20, 25, 30, 35, 40, 45, 50, 60, 70, 80, 90, 100, 200, 300, 400, 500, 1000, 1500 or about 2000° C. These values can be used to define a range, such as about 10 to about 50° C.

The conduit can include, or be formed from, a plurality of over laying panels. These panels can overlap each other to form the conduit having an external surface and an internal surface.

The composition can also include one or more shutters attached to the external surface of the plurality of overlaying panels. The one or more shutters can be capable of adjusting the size of the front opening, back opening, throat opening or any combination thereof. As such, the one or more shutters can be capable of adjusting the degree of front and back pitch. A feedback loop can also be used to adjust a size of the one or more shutters.

The feedback loop can be used to adjust the shutters to adjust the size of the panels to obtain or maintain choked flow in the conduit. The feedback loop can obtain the temperature of the system, or other appropriate measure, and adjust the size of the overlapping panels to obtain or maintain choked flow, or near choked flow, in the conduit.

The plurality of overlapping panels can be made of material capable of forming a conduit capable of changing size dimension and reducing pressure noise in a chromatography system using a highly-compressible fluid based mobile phase. The overlapping panels can be made of various materials. For example, the overlapping panels can be made of metals, polymer, rigid plastics, or any combination thereof.

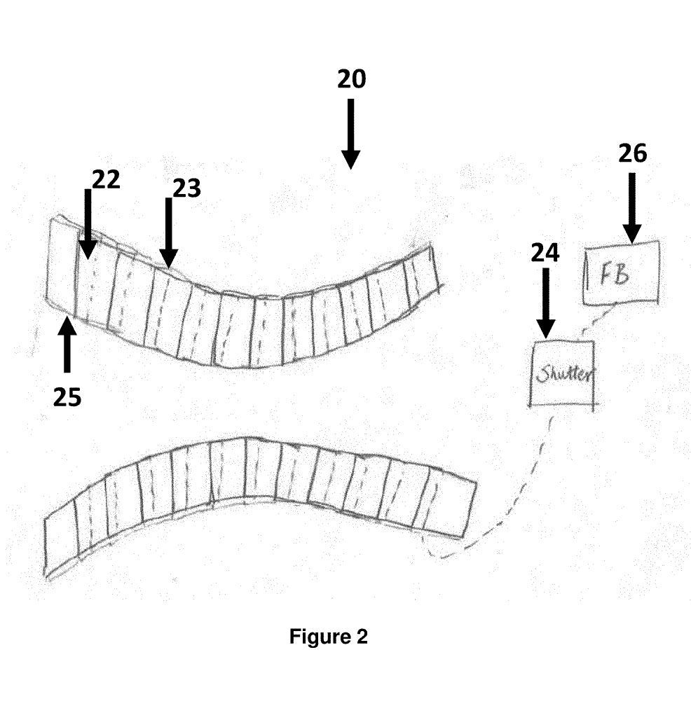

FIG. 2 show a composition 20 wherein the conduit is made of plurality of overlapping planes 22. The conduit has an external surface 23 and an internal surface 25. The shutter 24 is attached to the external surface 23 of the plurality of overlapping panels 22 and capable of adjusting the size of the front opening, back opening, throat section or any combination thereof to obtain or maintain choked flow, or near choked flow, in the throat section. The feedback loop 26 can be used to adjust the size of the one or more shutters 24.

In another embodiment, the present disclosure relates to a chromatography system including a pump for pumping a flow stream comprising a highly-compressible fluid or a highly-compressible fluid based mobile phase, a column disposed downstream of the pump, a detector disposed downstream of the column, a device or conduit (such as a convergent-divergent nozzle) disposed downstream of the column, and a back pressure regulator downstream of the device or conduit, e.g., nozzle.

The pump can be any pump capable of pumping a flow stream including a highly-compressible fluid based mobile phase through a chromatography system. The pump(s) can be capable of generating a multiple component mobile phase, e.g., carbon dioxide and at least one modifier. The pump can be capable of pumping the mobile phase as various flow rates including about 0.01 mL/min, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, 30, 40, or about 50 mL/min. These values can also be used to define a range, such as about 1 to about 10 mL/min. The pump can be capable of generating various system pressures including about 100 psi, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5500, 6000, 6500, 7000, 7500, 8000, 8500, 9000, 9500 or about 10000 psi. These values can also be used to define a range, such as about 1500 to about 4000 psi. The mobile phase can contain carbon dioxide and at least one modifier. The mobile phase can contain at least 10%, 20%, 30%, 40%, 50%, 60%, 70%, 80%, 90%, 95%, 98%, 99% or about 100% carbon dioxide. These values can also be used to define a range, such as about 50% to about 90% carbon dioxide. The modifier can be any solvent capable of being used in a chromatography system, such a methanol, acetonitrile, isopropanol, THF and ethanol.

The column can be any column capable of separating at least one analyte in a chromatography system. The detector can be any detector capable of qualitatively, quantitatively, or both determining at least one analyte in a chromatography system. In particular, the detector can be any that can be negatively affected, or substantially negatively affected, by noise due to fluctuation of mobile phase density. The back pressure regulator can be any back pressure regulator capable of regulating the pressure in a carbon dioxide based chromatography system. In some embodiments, the back pressure regulator is an active or automatic back pressure regulator. The back pressure regulator can include a movable valve shaft.

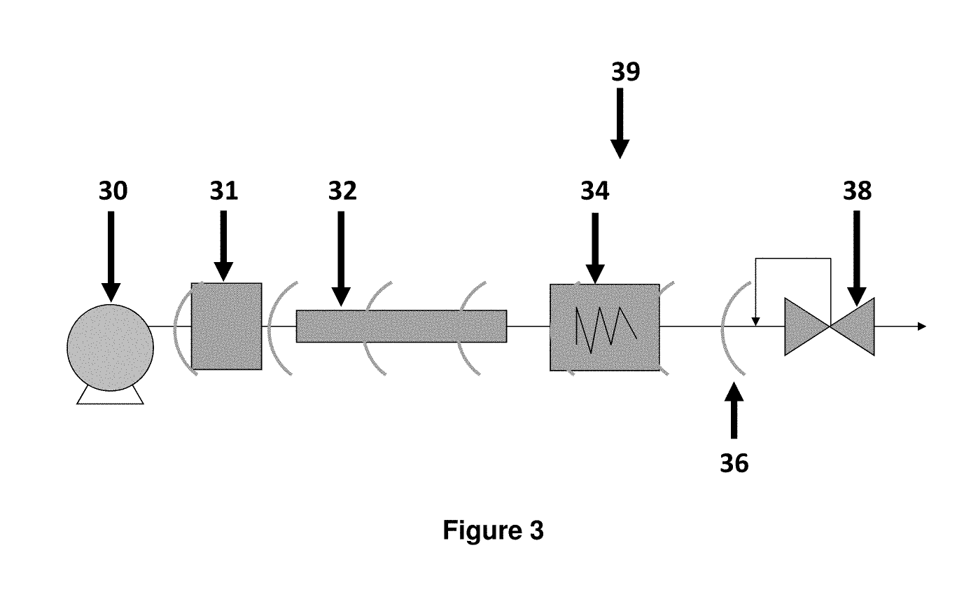

FIG. 3 shows an SFC system having density waves generated by the movement of an automated back pressure regulator (ABPR). The waves can propagate throughout the system and can interfere with and create changes in the chromatography system including the generation of baseline noise in a detector. In FIG. 3, pump 30 pumps a highly-compressible fluid based mobile phase to the SFC system 39. The highly-compressible fluid based mobile phase with the sample 31 flows to column 32 then to the detector 34. Downstream of the detector 34 is the ABPR 38. A valve shaft movement of ABPR 38 can generate pressure wave movement 36 upstream of the system which can pass through the detector 34. The wave energy can create density ripples or variations within the system and can be a significant cause of detector baseline noise.

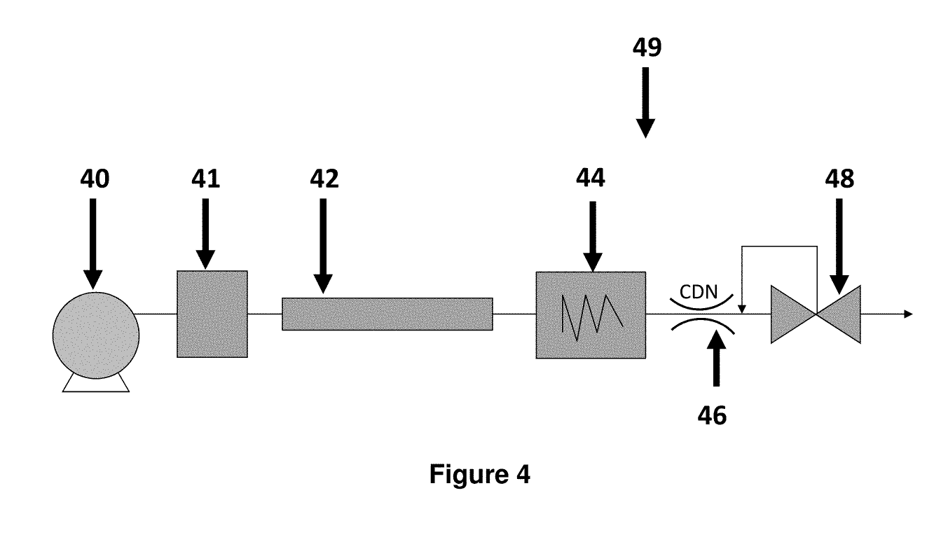

FIG. 4 shows a similar SFC system as shown in FIG. 3 with the addition of a convergent divergent nozzle (or conduit) between the detector and the ABPR. In FIG. 4, pump 40 pumps a highly-compressible fluid based mobile phase to the SFC system 49. The highly-compressible fluid based mobile phase with the sample 41 flows to column 42 then to the detector 44. Downstream of the detector 44 is the ABPR 48. Valve shaft movement of ABPR 48 can generate pressure wave movement upstream of the system which can pass through the detector 34. As shown in FIG. 4, the density waves generated by the movement of the ABPR 48 valve shaft can be reduced or stopped from propagating throughout the system past the convergent divergent nozzle 46. By placing the CDN 46 between the detector 44 and ABPR 48, pressure wave propagation can be significantly reduced where the highly-compressible fluid based mobile phase obtains choke or near choke flow conditions when passing through the throat of the CDN (e.g., conduit) 46.

The system can include a pressure transducer probe connected to, at or near the CDN capable of measuring the pressure of the mobile phase in the throat section area. The pressure transducer probe can be any pressure transducer.

Temperature control of the mobile phase can be used to obtain or maintain choked flow conditions at the throat of the CDN. The system can further include a heat exchanger connected to or in close proximity of the nozzle capable of heating the highly-compressible fluid based mobile phase flowing through the CDN. The heat exchanger can be any heat exchanger.

The system can further include a feedback controller connected to the detector and the heat exchanger. The feedback controller can be capable of determining the pressure noise in the detector and adjusting the heat exchanger to minimize the pressure noise. In one embodiment, the feedback controller can use the pressure transducer probe to measure the fluid pressure at the throat which can be used to calculate the temperature required to maintain choked flow.

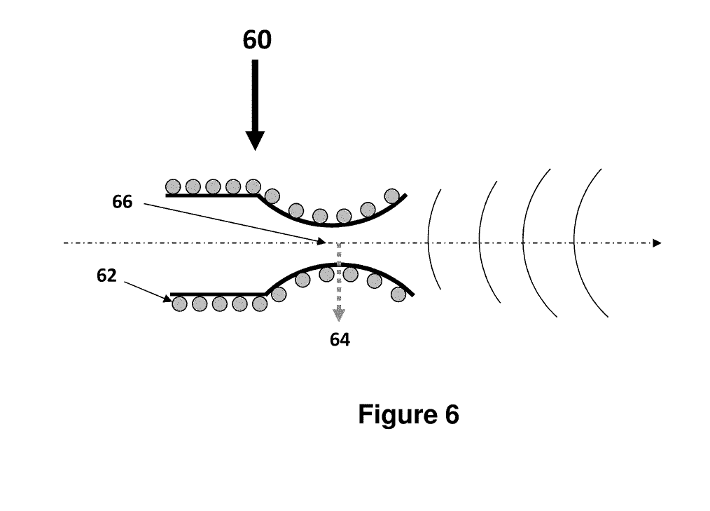

FIG. 6 shows a convergent divergent nozzle 60 having temperature control elements 62 to adjust the temperature of the mobile phase at the nozzle 60 to ensure choked flow. The nozzle 60 has a pressure transducer 64 to measure the pressure of the mobile phase at the throat 66 of the nozzle. In another embodiment, a feedback controller can be used with, or in place of a pressure transducer, to manipulate the throat temperature based on a preset criterion of acceptable detector noise. Minimization of baseline noise can be used to indicate whether choked flow condition is achieved.

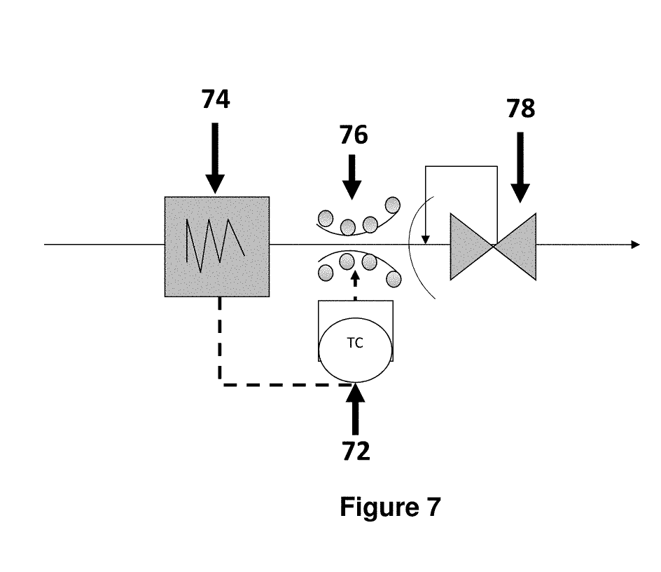

FIG. 7 shows a system 70 having a convergent divergent nozzle 76 and a temperature controller 72 to continuously adjust, if needed, the temperature of the mobile phase in the nozzle to obtain or maintain choked flow. The temperature controller 72 can be connected to the detector 74 and can make adjustments based on the detector 74 signal or baseline noise. For example, if the baseline noise of the detector 74 is higher than a specific value, the temperature controller will decrease or increase the temperature of the mobile phase in the nozzle to obtain choked flow.

Without wishing to be bound by theory, it is believed that the velocity of sound through a particular fluid is a state property and a function of temperature and pressure. Choked flow can be obtained or maintained by controlling the temperature and pressure of the fluid passing through a device or conduit's throat wherein the fluid velocity becomes equal, or substantially equal, to the sound velocity. To calculate choked flow condition in the device throat for a particular mass flow rate of the mobile phase, the density and the speed of sound can be first calculated at the specified throat pressure and 0° C. from the following equations (Eq. 1 to 4).

$$\begin{matrix}ρ = ρ ( T , P ) & ( 1 ) \\ s = s ( T , P ) & ( 2 ) \\ V = \frac{\dot{m}}{ρ} & ( 3 ) \\ u = \frac{V}{A} & ( 4 )\end{matrix}$$

Where, ρ is the fluid density at the throat, T is the fluid temperature at the throat, P is the fluid pressure at the throat, s is the speed of sound at T and P, V is the volumetric flowrate of the fluid, m is the mass flowrate, u is the flow velocity and A is the cross-sectional area of the throat. Generally, the m and the P can be specified for a particular situation, whereas the T and the A can be manipulated to achieve choked-flow. To detect T for a specified \dot{m}, P, and A, the T can be calculated iteratively from equations 1 to 4. To calculate A when the other parameters are specified, equations 1 to 3 can be used to calculate V and s, from which A can be calculated as:

$$A = \frac{V}{s} \qquad ( 5 )$$

By using thermodynamic data of neat carbon dioxide from national institute of standards and technology (NIST), the conditions of choked flow can be calculated. For example, if the diameter of the throat of a CDN is 40 μm, the mass-flow rate is 2 g/min, and the pressure at the throat is 1200 psi, maintaining a temperature of 363.7° C. at the throat can achieve choked flow conditions in the CDN. Changes in any of these parameters can require changes in other parameters to obtain or maintain choked flow conditions. For example, if the mass-flow is changed to 2.2 g/min, then the throat temperature should be maintained at 272.35° C. to maintain choked flow condition. If the throat diameter is changed to 45 μm, to maintain choked flow at 2.2 g/min the temperature should be 540.55° C. Similar calculations can be performed based on physical property date of CO₂+ additive (e.g., methanol) mixtures.

The system temperature and pressure can vary depending on the application and the components within the system. The temperature of the system, or of any one component in the system, e.g., mobile phase, can be −50° C., −45, −40, −35, −30, −25, −20, −15, −10, −5, 0, 5, 10, 15, 20, 25, 30, 35, 40, 45, 50, 60, 70, 80, 90, 100, 200, 300, 400, 500, 1000, 1500 or about 2000° C. These values can also be used to define a range, such as about −100° C. to about 300° C.

The pressure of the system, or of any one component in the system, e.g., mobile phase, can be about 100 psi, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5500, 6000, 6500, 7000, 7500, 8000, 8500, 9000, 9500 or about 10000 psi. These values can also be used to define a range, such as about 1500 to about 4000 psi.

In another embodiment, the nozzle (i.e., the device) can include two or more channels wherein each channel has a throat section having a different cross-sectional area. As stated above, in order to reduce pressure noise in chromatographic systems that use a highly-compressible fluid based mobile phase a device, such as a convergent divergent nozzle, can be used to obtain choked flow in the throat section of the nozzle, thereby reducing the pressure propagation through the upstream of the flow. During the analysis of the samples in chromatography systems, the temperature and/or the pressure of the flow can vary. As temperature and/or pressure of the system varies, the area of the throat section of the nozzle should be modified to maintain or obtain choked flow (Equation (5)). In order to reduce propagation of pressure noise (obtaining choked flow) in these conditions, the nozzle (conduit) can have channels with different throat sections, to obtain choked flow in at least one of the throats. In some embodiments, the flow of the highly-compressible fluid based mobile phase can be directed to one or more of these channels.

In another embodiment, choked flow can be achieved by changing the diameter of the throat section of the device, e.g., convergent divergent nozzle. In these embodiments, it may be faster, easier or both, to adjust the physical parameter of the conduit that the temperature, pressure or both of the mobile phase. For example, a change in flow rate or pressure can result in a change in the throat temperature. With neat CO₂, if the mass flow rate is changed from 2 to 4 g/min, assuming a throat pressure of 2000 psi and a throat diameter of 20 μm, the required throat temperature to achieve choked-flow condition should be decreased from about 73.9 to about 50.85° C. If the throat diameter is also changed to 28.2 μm from 20 μm when the flow rate is increased from 2 to 4 g/min, then the required temperature to achieve choked-flow condition should be decreased from about 73.9 to about 73.55° C. Decreasing temperature from 73.9 to 50.85° C. along with equilibrating the system can take a longer time as compared to manipulating the throat diameter while keeping the temperature almost unchanged.

In another embodiment, the present disclosure relates to a method of improving the performance of a chromatography system including the steps of filtering pressure noise in a highly-compressible fluid based mobile phase flowing through the system. The improved performance can be achieved by decreasing baseline noise in a detector in the chromatography system. Decreasing the baseline noise can be achieved by using a device, such as a convergent divergent nozzle and by obtaining choked flow in the highly-compressible fluid based mobile phase flowing in the throat section of the nozzle.

Filtering can include reducing the propagation of pressure or density pulses from a back pressure regulator in a chromatography system. Further, filtering pressure noise can be achieved by obtaining choked flow in the highly-compressible fluid based mobile phase flowing through the system. Obtaining choked flow in the highly-compressible fluid based mobile phase flowing in the throat section of the nozzle can be achieved through various parameters. For example, by varying the temperature of the fluid or by adjusting the diameter of the throat of the nozzle, choked flow can be achieved in chromatography systems resulting in filtering or reducing the pressure noise.

The systems and method of the present disclosure can reduce detector noise associated with pressure or density pulses. The noise of one or more detectors in a chromatography system can be reduced by, or over, about 5%, 10%, 15%, 20%, 25%, 30%, 35%, 40%, 45% or about 50%. These values can be used to define a range, such as about 10% to about 30%. The S/N of one or more detectors in a chromatography system can be increased by, or over, about 5%, 10%, 15%, 20%, 25%, 30%, 35%, 40%, 45% or about 50%. These values can be used to define a range, such as about 25% to about 50%.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

As used herein, the term “about” means that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments.

1. A composition for reducing pressure noise in a chromatography system comprising:
a conduit having:
a front opening with a first cross-sectional area,
a back opening with a second cross-sectional area, and
a throat section with a third cross-sectional area located between the front and back opening, wherein the third cross-sectional area is less than about 90% of both individual values of the first and second cross-sectional areas; and
a heat exchanger in thermal communication with the conduit.

2. The composition of claim 1 wherein the cross-sectional area of the front opening, back opening, and the throat opening section are substantially circular.

3. The composition of claim 1 wherein the throat section is located closer to the front opening than to the back opening.

4. The composition of claim 1 wherein the throat section is located closer to the back opening than to the front opening.

5. The composition of claim 1 wherein the conduit comprises plastic, metal or a combination thereof.

6. The composition of claim 1 wherein the conduit comprises a plurality of overlaying panels which form the conduit, the conduit having an external surface and an internal surface;
the composition further comprises one or more shutters attached to the external surface of the plurality of overlaying panels configured to adjust the size of the front opening, back opening, throat section, or combinations thereof; and
a feedback loop to adjust a size of the one or more shutters.

7. (canceled)

8. The composition of claim 1 wherein the conduit has a relatively constant pitch between the front opening and the throat section and between the back opening and the throat section.

9. A chromatography system comprising:
a pump for pumping a flow stream comprising a highly-compressible fluid based mobile phase;
a column disposed downstream of the pump;
a detector disposed downstream of the column;
a convergent-divergent nozzle disposed downstream of the column; and
a back pressure regulator downstream of the nozzle.

10. The system of claim 9 wherein the highly-compressible fluid comprises carbon dioxide.

11. (canceled)

12. The system of claim 9 wherein the nozzle has a front opening having a first cross-sectional area, a back opening having a second cross-sectional area, and a throat section having a third cross-sectional area located between the first and second openings, the third cross-sectional area being less than about 90% of both individual values of the first and second cross-sectional areas.

13. The system of claim 9 wherein the back pressure regulator has a moveable valve shaft.

14. The system of claim 9 further comprising a pressure transducer probe connected to the nozzle configured to measure the pressure of the mobile phase in the throat section, and a heat exchanger connected to or in close proximity of the nozzle configured to heat the highly-compressible fluid based mobile phase flowing through the nozzle.

15. The system of claim 14 further comprising a feedback controller connected to the detector and the heat exchanger, wherein the controller is configured to determine the pressure noise in the detector and adjusting the heat exchanger to minimize the pressure noise.

16. The system of claim 9 wherein the nozzle has two or more channels wherein each channel has a throat section having a different cross-sectional area.

17. The system of claim 12 wherein at least the first, second or third cross-sectional area can be adjustable.

18. (canceled)

19. A method of improving the performance of a chromatography system comprising the steps of:
filtering pressure noise in a CO₂-based mobile phase flowing through the system utilizing a convergent-divergent nozzle positioned between a detector and a back pressure regulator in the system.

20. The method of claim 19 wherein the improved performance comprises decreasing baseline noise in a detector in the chromatography system.

21. The method of claim 19 wherein filtering comprises reducing the propagation of one or more pressure pulses from a back pressure regulator in the chromatography system.

22. The method of claim 19 wherein filtering comprises reducing the propagation of one or more density pulses from a back pressure regulator in the chromatography system.

23. The method of claim 19 wherein filtering comprises obtaining choked flow in the CO₂-based mobile phase flowing through the system.

24.-25. (canceled)
